(19) United States
(12) Patent Application Publication
(10) Pub. No.: US 2008/0289251 A1
(43) Pub. Date: Nov. 27, 2008

(54) Use of a Breathable Polyolefin Film for Agricultural Applications

(75) Inventors: Fabrizio Lori, Cerese di Virgilio (IT); Graziano Bortoletto, Zero Branco (IT)

Correspondence Address: SALTAMAR INNOVATIONS, 30 FERN LANE, SOUTH PORTLAND, ME, 04106, US

(73) Assignee: NUOVA PANSAC S.P.A., Milano (IT)

(21) Appl. No.: 12/097,261

(22) PCT Filed: Dec. 19, 2006
(86) PCT No.: PCT/EP2006/012207

§ 371 Date: Jun. 13, 2008

(30) Foreign Application Priority Data
Dec. 19, 2005 (IT) MI2005A002412
Dec. 19, 2006 (EP) PCT/EP2006/012207

(51) Int. Cl. A01G 13/02; A01G 9/14

(52) U.S. Cl. 47/29.4; 47/17; 47/32.3

(57) ABSTRACT

The present invention relates to an agricultural use of a breathable polyolefin film (1), filled with CaCO³ and/or MgO-based fillers, having a water vapor permeability, based on ASTM D 6701-01 standards, of at least 500 g/m² H₂O/24 h and having an air permeability, based on ATICELCA MC 19-74 and TAPPI T 460 om-88 standards, below 100 min/cc of air, and having an average basis weight of 10 to 60 g/m².

A breathable polyolefin film, particularly a laminated breathable polyolefin film, and the agricultural use thereof, are hereby disclosed.

The term “agricultural use” employed herein is intended, among other, for the manufacture of covers for greenhouses, crops, plants and flowers and for packaging of fresh cut flowers.

Agricultural use of polyolefin films—usually polyethylene films—is known in the art.

However, conventional polyolefin films suffer from certain drawbacks, when used in agriculture.

For example, greenhouses are subject to high microclimatic day/night fluctuations.

Also, polyethylene films are unsuitable for preserving fresh cut flowers.

A further drawback is the fragility of polyethylene, particularly when it is designed to be extensively exposed to the atmospheric agents.

The object of the present invention is to obviate the drawbacks of prior art and particularly those set out hereinbefore providing the use of a film material that allows to passively maintain temperature, humidity, carbon dioxide concentration and light intensity conditions within an optimal range for proper growth or preservation of plants (either with or without leaves), vegetables and flowers.

Such object is fulfilled by the use of a film as defined in claims 1 and 6.

Further advantages may be achieved by the features of the dependent claims.

Some possible embodiments, as claimed in the enclosed claims, will be described hereinafter with reference to the drawings, where:

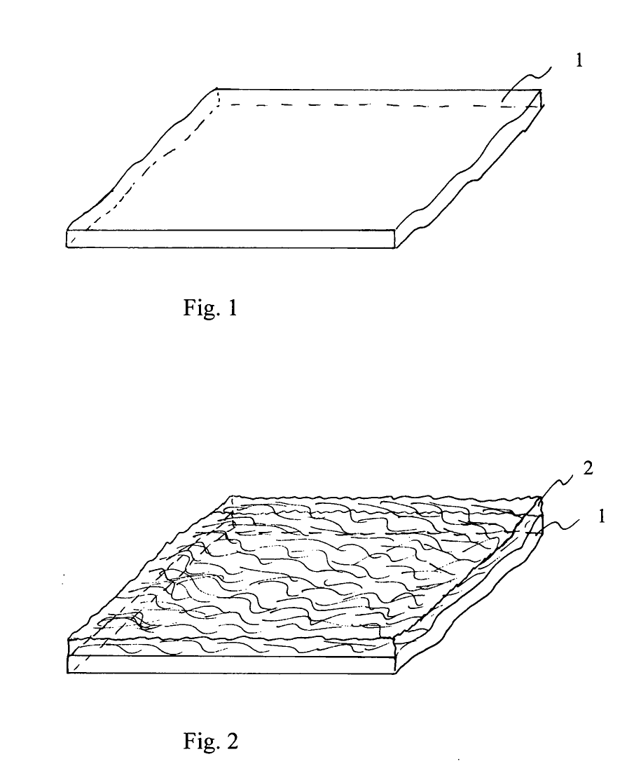

FIG. 1 shows a breathable calcium carbonate- and/or magnesium oxide-filled polyolefin film;

FIG. 2 shows a laminated film comprising a breathable polyolefin layer joined to a nonwoven layer.

A first embodiment (FIG. 1) uses a breathable polyolefin film 1 obtained from a CaCO₃-filled film and stretched in the longitudinal direction (machine direction) and/or in the transverse direction, during manufacture.

The CaCO₃ filler has an average particle size of 0.5 to 6 μm and is preferably processed for its surface to become hydrophobic.

The filler is 30% to 70% by weight of the polyolefin film, more preferably the filler ranges from 40% to 65% with respect to the weight of the film.

Obviously, the CaCO₃ filler may be blended with other inorganic fillers, e.g. MgO.

Longitudinal stretching ratios to obtain the desired breathability may range from 1:1.5 to 1:2.5.

Also the transverse stretching ratios may range from 1:1.5 to 1:2.5.

Preferably the polyolefin film 1 is formed of linear low density polyethylene (LLDPE).

As an alternative, the polyolefin film 1 may be formed of low density polyethylene (LDPE) or medium density polyethylene (MDPE).

Polyethylene copolymers may be also used, which have α-olefins with 4 to 10 carbon atoms (1 butene, 1 pentene, 1 hexene, 1 heptene, 1 octene, 4 methyl-1 pentene).

The breathable polyolefin film 1 has a water vapor permeability (measured using the PERMATRAN 100K analyzer of MOCON INC., whose operation is based on ASTM D 6701-01 standard) of at least 500 g/m²H₂O/24 h.

Preferably, the breathable polyolefin film 1 has a water vapor permeability of at least 1000 g/m²H₂O/24 h and more preferably of at least 20,000 g/m²H₂O/24 h.

The breathable polyolefin film 1 has an average basis weight of 10 to 60 g/m² and more preferably of 25 to 40 g/m².

Air permeability (as determined using a Gurley porosimeter compliant with ATICELCA MC 18-74 and TAPPI T 460 om-88 standards) is lower than 100 min/cc of air and preferably lower than 50 min/cc of air.

The use of the breathable polyolefin film 1 provides considerable advantages compared to traditional polyolefin films.

Thanks to its air breathability and water vapor permeability, the film 1 allows release of the water vapor emitted from the plants during daytime insolation, thereby maintaining the humidity in the environment enclosed by the film within limited ranges.

Avoiding water vapor excesses in the environment enclosed by the film, the risk of harmful ice formation on the plants during the nighttime is avoided or at least reduced.

When packaging fresh cut flowers and plants, that are “living” products, the breathability of the film maintains the carbon dioxide and oxygen concentrations in normal ranges and hence allows a longer preservation of these products.

Further it was experimentally verified that the breathable polyolefin film 1 according to this invention provides (in addition to lower humidity fluctuations within the environment enclosed by the film) also lower temperature fluctuations.

Particularly in greenhouses, whose cover is made of the breathable polyolefin film 1, provides a reduced heating during the daytime and a reduced cooling during the nighttime.

Even though the inventors do not intend to provide a scientific explanation for the results experimentally verified, they believe that the reduced daytime heating and nighttime cooling result from a certain ability of the polyolefin film to reflect infrared radiation.

During the daytime, the polyolefin film considerably attenuates the passage of IR radiation, which does not contribute to photosynthesis, thereby preventing any excessive increase of temperature within the greenhouse.

During the nighttime, infrared radiation emitted from the ground is reflected and retained within the greenhouse by the polyolefin film, wherefore heat is maintained therein.

The inventors believe that this partial IR radiation screening effect is caused by the presence of fillers in the polyolefin layers, particularly of calcium carbonate (CaCO₃) fillers used to assist pore formation during the stretching step.

However, the polyolefin film allows the passage of radiations that are used for photosynthesis, i.e. having wavelengths in a range of 400 to 575 nm, with no excessive attenuation thereof.

If necessary, the breathable polyolefin film 1 may contain additives that can filter UV radiation or at least slow down film degradation when the film is continuously exposed to the atmospheric agents.

The breathable polyolefin film 1 may further contain styrenic thermoplastic elastomers.

In this case, the amount of styrenic thermoplastic elastomers may be 10% to 35% by weight, the amount of filler is 45% to 55% by weight and the amount of olefins is 10% to 35% by weight.

According to a possible embodiment, the styrene thermoplastic elastomer may be KRATON® (available from KRATON POLYMERS RESEARCH S. A., Belgium) or SEPTON® (available from KURURAY Co., LTD., Japan).

The addition of styrenic thermoplastic elastomers imparts elastic properties to the breathable polyolefin film.

This property is particularly appreciated when wrapping delicate products such as flowers, as the film follows the contour of the product without damaging it.

In a second more preferred embodiment, the breathable polyolefin film 1 (possibly added with styrenic thermoplastic elastomers) is joined to a nonwoven fabric 2, thereby forming a laminated film (see FIG. 2).

This joining process may be carried out by well-known technologies, such as hot melt adhesives or heat sealing.

Preferably, the nonwoven fabric is a spun-bonded polypropylene-based nonwoven fabric.

The laminated film so obtained has a water vapor permeability (as measured using the PERMATRAN 100K analyzer, available from MOCON INC., whose operation is based on ASTM D 6701-01 standard) of at least 500 g/m²H₂O/24 h.

Preferably, the water vapor permeability of the laminated film is of at least 1.000 g/m²H₂O/24 h and more preferably of at least 20.000 g/m²H₂O/24 h.

Air permeability (determined with a Gurley porosimeter compliant with ATICELCA MC 18-74 and TAPPI T 460 om-88 standards) is lower than 100 min/cc of air and preferably lower than 50 min/cc of air.

The breathable polyolefin film 1 has an average basis weight of 10 to 60 g/m² and more preferably of 25 to 40 g/m².

The breathable polyolefin layer 1 affords the above mentioned advantages.

The nonwoven layer 2 provides further advantages.

First, it adds tensile advantages, increasing the mechanical strength of the film material, in both longitudinal and transverse direction.

Furthermore, the nonwoven fabric layer 2 cooperates with the breathable polyolefin layer 1 to create diffused lighting conditions within the space enclosed by the laminated film, thereby promoting an even growth of the plants, regardless of their location inside the greenhouse.

Furthermore, the nonwoven fabric 2 increases the heat insulation of the film.

1-13. (canceled)

14. A method of protecting agricultural plants, comprising the steps of:
Providing a breathable polyolefin film, filled with MgO based fillers, having a water vapor permeability of at least 500 g/m²H₂O/24 h, having an air permeability below 100 min/cc of air, and having an average basis weight of 10 to 60 g/m²;
enclosing said plant at least from a single direction, with said film.

15. A method of protecting agricultural plants as claimed in claim 14, wherein said step of enclosing comprises covering at least a portion of a greenhouse with said film.

16. A method of protecting agricultural plants as claimed in claim 15, wherein said film further comprises styrenic thermoplastic elastomers.

17. A method of protecting agricultural plants as claimed in claim 14, wherein said plants being flowers, and wherein said step of enclosing comprises at least partially wrapping said flowers in said film.

18. A method of protecting agricultural plants as claimed in claim 17, wherein said film further comprises styrenic thermoplastic elastomers.

19. A method of protecting agricultural plants as claimed in claim 14, wherein said plants are agricultural produce, and wherein said step of enclosing comprises at least partially wrapping said produce in said film.

20. A method of protecting agricultural plants as claimed in claim 14, wherein said film is having a water vapor permeability of at least 1.000 g/m²H²O/24 h.

21. A method of protecting agricultural plants as claimed in claim 14, wherein said film is having a water vapor permeability of at least 20.000 g/m²H₂O/24 h.

22. A method of protecting agricultural plants as claimed in claim 14, wherein said film is having air permeability below 50 min/cc of air.

23. A method of protecting agricultural plants as claimed in claim 14, wherein said film is having an average basis weight of 25 to 40 g/m².

24. A method of protecting agricultural plants as claimed in claim 14, wherein said film comprises a low density polyethylene (LDPE) or a medium density polyethylene.

25. A method f protecting agricultural plants, as claimed in claim 14, wherein said film further comprises a nonwoven fabric sheet laminated to said polyolefin film, wherein the combination of laminated films has a water vapor permeability of at least 500 g/m²H₂O/24 h, an air permeability below 100 min/cc of air, and an overall average basis weight of 10 to 60 g/m².

26. A method of protecting agricultural plants, comprising the steps of:
Providing a breathable polyolefin film, filled with CaCO₃ based fillers, having a water vapor permeability of at least 500 g/m²H₂O/24 h, having an air permeability below 100 min/cc of air, and having an average basis weight of 10 to 60 g/m²;
enclosing said plant at least from a single direction, with said film.

27. A method of protecting agricultural plants as claimed in claim 26, wherein said step of enclosing comprises covering at least a portion of a greenhouse with said film.

28. A method of protecting agricultural plants as claimed in claim 27, wherein said film further comprises styrenic thermoplastic elastomers.

29. A method of protecting agricultural plants as claimed in claim 26, wherein said plants being flowers, and wherein said step of enclosing comprises at least partially wrapping said flowers in said film.

30. A method of protecting agricultural plants as claimed in claim 29, wherein said film further comprises styrenic thermoplastic elastomers.

31. A method of protecting agricultural plants as claimed in claim 26, wherein said plants are agricultural produce, and wherein said step of enclosing comprises at least partially wrapping said produce in said film.

32. A method of protecting agricultural plants as claimed in claim 26, wherein said film is having a water vapor permeability of at least 1.000 g/m²H₂O/24 h.

33. A method of protecting agricultural plants as claimed in claim 26, wherein said film is having a water vapor permeability of at least 20.000 g/m²H₂O/24 h.

34. A method of protecting agricultural plants as claimed in claim 26, wherein said film is having air permeability below 50 min/cc of air.

35. A method of protecting agricultural plants as claimed in claim 26, wherein said film is having an average basis weight of 25 to 40 g/m².

36. A method of protecting agricultural plants as claimed in claim 26, wherein said film comprises a low density polyethylene (LDPE) or a medium density polyethylene.

37. A method of protecting agricultural plants, as claimed in claim 26, wherein said film further comprises a nonwoven fabric sheet laminated to said polyolefin film, wherein the combination of laminated films has a water vapor permeability of at least 500 g/m²H₂O/24 h, an air permeability below 100 min/cc of air, and an overall average basis weight of 10 to 60 g/m²
